(19) United States
(12) Patent Application Publication
(10) Pub. No.: US 2010/0269139 A1
(43) Pub. Date: Oct. 21, 2010

(54) BROADCASTING RECEIVER AND OPERATION METHOD THEREOF

(75) Inventor: Yong Chul Kim, Gumi-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/376,674

(22) PCT Filed: Jul. 12, 2007
(86) PCT No.: PCT/KR2007/003379

§ 371 Date: Jun. 23, 2010

(30) Foreign Application Priority Data
Aug. 9, 2006 (KR) 10-2006-0075101

(51) Int. Cl. H04N 5/445

(52) U.S. Cl. 725/50

(57) ABSTRACT

A broadcast receiver and an operating method thereof are disclosed. The present invention includes extracting additional information from a received broadcasting signal, obtaining EPG information associated with a schedule of broadcasting programs using the extracted additional information, generating progress status information by checking a progress status in which a broadcasting program selected from the broadcasting programs is currently processed, and configuring broadcast information by adding the generated progress status information to the obtained EPG information. Accordingly, the present invention obtains reserved recording information and reserved viewing information for a broadcast program from EPG information to display via broadcast guide window and displays progress' status information for a recorded or played broadcast program via a progress status window, thereby facilitating a user to recognize a recording progress status or a play progress status of a broadcast program instantly.

### FIELD OF THE INVENTION

The present invention relates to broadcast reception, and more particularly, to a broadcast receiver and an operating method thereof. Although the present invention is suitable for a wide scope of applications, it is particularly suitable for flat panel displays including an OLED (Organic Light-Emitting Diode) panel, a PDP (Plasma Display Panel), an LCD Liquid Crystal Display and the like, other video devices including a projection television (TV), a monitor and the like, and broadcast receivers including an analog TV, a digital TV and a satellite TV in NTSC (National Television Standards Committee), PAL (Phase Alternating Line), SÉCAM (Séquentiel Couleur À Mémoire) or the like.

### DISCUSSION OF THE RELATED ART

Generally, a broadcast receiver such as a TV and the like plays a role in receiving a broadcast signal and then displaying a corresponding image. In particular, a digital TV (television) is capable of providing various functions in addition to playback of images having high quality in a manner of converting a received broadcast signal to a digital format.

In digital broadcasting, video and audio streams are broadcasted by being compressed to digital information and information for system and various broadcast programs are broadcasted by being compressed to be adapted to PSIP (program and system information protocol) as well.

The PSIP is a protocol by ATSC (advanced television systems committee) for terrestrial and cable digital broadcasting, in which protocols for information for various broadcast programs and system information are defined. In the PSIP, signals encoded by MPEG (moving picture experts group) standard are parsed to provide various kinds of information for programs. In particular, a broadcast receiver decodes information associated with a broadcast program from data included in a received broadcast signal that contains video and audio information as well and then informs a used of the program associated information via an electronic program guide (EPG) picture shown in FIG. 1 for example.

Meanwhile, a latest broadcast receiver has a function of PVR (personal video recorder) as well as a function of receiving a broadcast signal and then displaying a corresponding video and an EPG picture.

According to the PVR function, a video is recorded on a storage medium such as a built-in hard disc drive (HDD) or the recorded video can be played back. For instance, the PVR function provides functions further enhanced than those of the conventional VCR though a time-shift function, an instant replay function in the course of live broadcast viewing, and a reserved recording and playing function as well as a basic recording function.

Moreover, the PVR function is advantageous in enabling a high image quality digital broadcast to be recorded/reproduced in/from a storage medium at any time. And, the PVR function provides various additional services. For example of one of the various additional services, a video captured by a user is stored in a storage medium, a necessary part of the stored video is selectively read out through a fast search, the read part is then conveniently displayed.

In the above-mentioned general broadcast receiver and operating method thereof, it is able to display information for various broadcast programs, a presence or non-presence of a reserved recording of a specific broadcast, and a presence or non-presence of a reserved viewing of a corresponding broadcast program only, through EPG picture as shown in FIG. 1. For instance, in FIG. 1, a mark 2 (▪) indicates that a recording of a broadcast program ‘News’ broadcasted on a fourth channel (CH. 4) is reserved. And, a mark 4 (★) indicates that a viewing of a broadcast program ‘Inset Collecting’ broadcasted on a fifth channel (CH. 5) is reserved.

However, a user is just informed which broadcast program is currently reserved for a recording or viewing but is unable to have information indicating how far a recording of the corresponding broadcast program progresses or how far a viewing time of the corresponding broadcast program progresses.

### SUMMARY OF THE INVENTION

Accordingly, the present invention is directed to a broadcast receiver and an operating method thereof that substantially obviate one or more problems due to limitations and disadvantages of the related art.

An object of the present invention is to provide a broadcast receiver and an operating method thereof, by which an overall progress status of a broadcast program is provided to a user together with an electronic program guide (EPG) picture to facilitate the user to recognize how far a recording of the corresponding broadcast program progresses or how far a viewing time of the corresponding broadcast program progresses.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of operating a broadcast receiver according to the present invention includes the steps of extracting additional information from a received broadcasting signal, obtaining EPG information associated with a schedule of broadcasting programs using the extracted additional information, generating progress status information by checking a progress status in which a broadcasting program selected from the broadcasting programs is currently processed, and configuring broadcast information by adding the generated progress status information to the obtained EPG information.

In another aspect of the present invention, a broadcast receiver includes a broadcast signal receiving unit extracting additional information from a received broadcasting signal, a broadcast information detecting unit detecting EPG information associated with a schedule of broadcasting programs using the extracted additional information, a status detecting unit generating progress status information by checking a progress status in which a broadcasting program selected from the broadcasting programs is currently processed, and a broadcast information configuring unit configuring broadcast information by adding the generated progress status information to the obtained EPG information.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram of a general electronic program guide (EPG) picture;

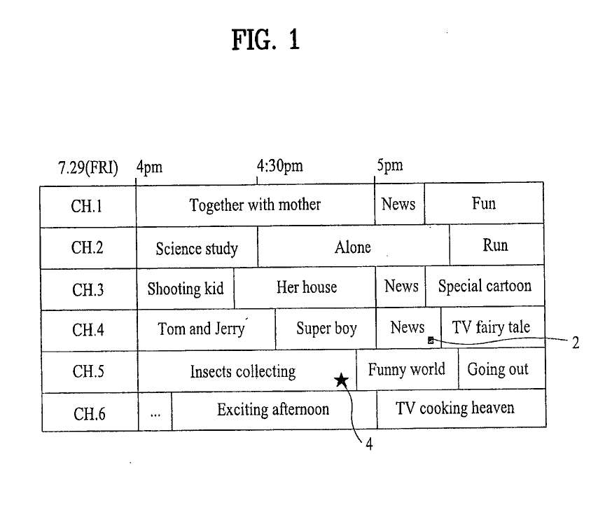

FIG. 2 is a flowchart of a method of operating a broadcast receiver according to one embodiment of the present invention;

FIG. 3 is a diagram of an example of displaying a broadcast guide window and a progress status window according to the present invention;

FIG. 4 is a diagram of an example of a progress status window;

FIG. 5 is a flowchart of a method of operating a broadcast receiver according to another embodiment of the present invention;

FIG. 6 is a block diagram of a broadcast receiver according to an embodiment of the present invention; and

FIG. 7 is a detailed block diagram of a central processing unit according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

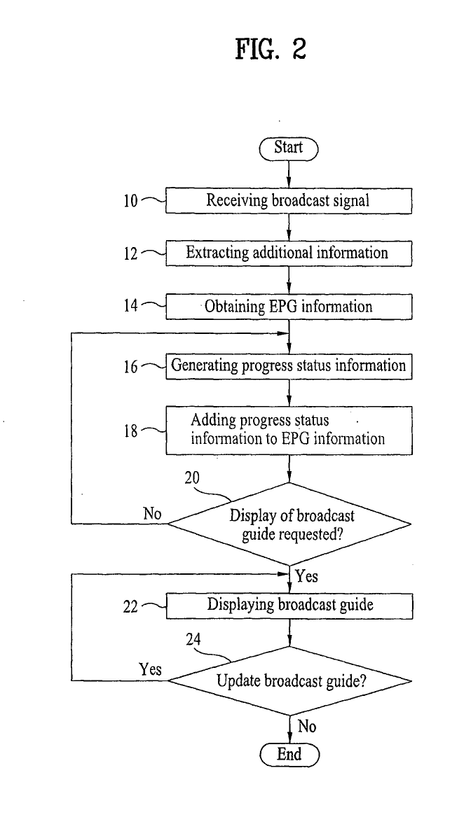

A method of operating a broadcast receiver according to the present invention is explained in detail with reference to FIGS. 2 to 5 as follows.

The method shown in FIG. 2 is executed in a broadcast receiver.

First of all, the broadcast receiver receives a broadcast signal (S10). In this case, the broadcast signal includes at least one of a video signal, an audio signal, and a data signal.

After completion of the step S10, additional information included in the data signal of the received broadcast signal is extracted (S12).

After completion of the step S12, information for an electronic program guide (hereinafter abbreviated EPG) associated with schedules of broadcast programs is obtained using the extracted additional information (S14). To help the understanding of the present invention, EPG information is exemplarily explained as follows.

First of all, a broadcast signal received by a broadcast receiver can include a PSIP table. The PSIP able includes an event information table (hereinafter abbreviated EIT). In this case, ‘event’ means a broadcast program. The EIT can contain information for identifying an event, information for a title of a broadcast program, and information for a start time and a sustain time of a broadcast program. The EPG information can be obtained from the information contained in the EIT. Optionally, the EPG information can be obtained from another source as well as the EIT. In this case, the EPG information can further include synopsis and information for broadcast date, genre and access service availability of each broadcast program.

After completion of the step S14, a currently processed progress status of a broadcast program, which is selected in real-time by a user or a reservation from broadcast programs, is checked. Progress status information is then generated using a result of the check (S16). In this case, the reservation means a reservation of a broadcast program recording or a broadcast program viewing.

In particular, a status that a recording of ‘selected broadcast program’ has progressed is checked and progress status information is then generated based on a result of the check. Alternatively, a status that a playback of ‘selected broadcast program’ currently viewed by a user progresses is checked and progress status information is then generated based on a result of the check.

The progress status information includes at least one of a presence or non-presence of a recording or playback of ‘selected broadcast program’, a recording or play start time of ‘selected broadcast program’, a recording or play end time of ‘selected broadcast program’, a current recording or play progress complete quantity of ‘selected broadcast program’, and a total recording or play quantity of ‘selected broadcast program’. In this case, the current recording or play quantity can be represented by a percent or time unit to a total recording or play quantity.

And, the aforesaid step S16 can be executed when a specific broadcast program within the EPG information is recorded or played back.

After completion of the step S16, broadcast information is configured by adding the progress status information to the EPG information (S18).

After completion of the step S18, it is decided whether a display of a broadcast guide is requested (S20).

If it is decided that the display of the broadcast guide is requested, the broadcast guide is displayed using the configured broadcast information (S22). In particular, if the display of the broadcast guide corresponding to the EPG information is requested, a broadcast guide window corresponding to the EPG information is displayed. Or, if the display of the broadcast guide corresponding to the progress status information is requested as well as the broadcast guide corresponding to the EPG information, a progress status window for displaying progress status information is displayed together with the broadcast guide window.

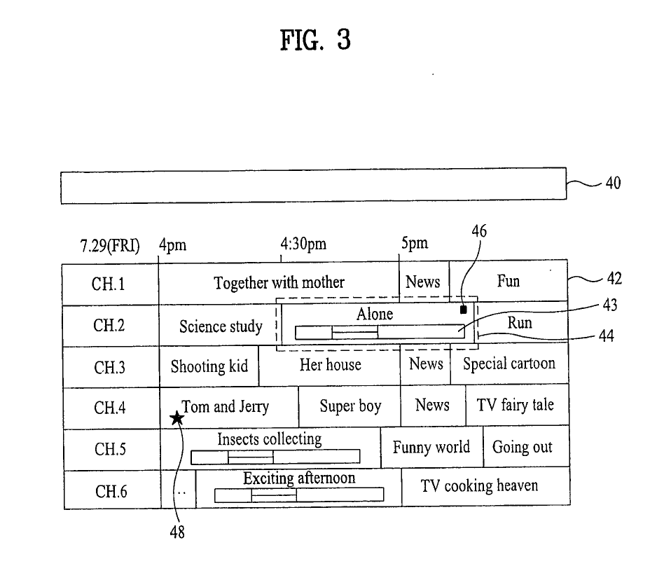

To help the understanding of a step S22, FIG. 3 is referred to.

Referring to FIG. 3, a broadcast guide window 42 can use a mark (▪) 46 to represent a status that a recording of a selected broadcast program is reserved or use another mark 48 (★) to represent a status that a viewing of the selected is reserved. Moreover, the broadcast guide window 42 is capable of representing a status that the recording of the selected broadcast program has ended.

According one embodiment of the present invention, a progress status window 43 can be displayed in a manner of being overlapped within a broadcast program 44 selected from upper lists appearing on the broadcast guide window 42. In this case, the upper list means start and end times of a broadcast program and titles of broadcast programs per broadcast channel.

According to another embodiment of the present invention, a progress status window 40 can be provided separate from the broadcast guide window 42.

According to a further embodiment of the present invention, instead of being always displayed on a screen, a progress status window can be displayed, to meet a user's request, in a pop-up figure together with the broadcast guide window 42 on a specific space of the screen, e.g., as a box figure on a space of the screen where the window 40 is located.

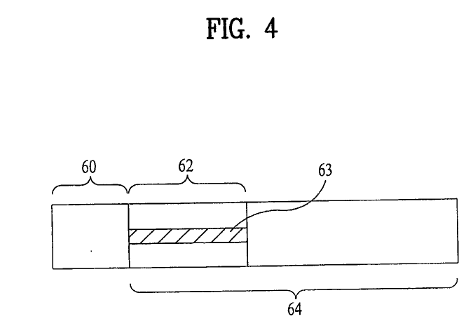

As mentioned in the foregoing description, the progress status window can be displayed in various ways. And, the displayed progress status window can have various figures. For instance, the progress status window can be graphically represented as a progress bar, as shown in FIG. 4. So, a user is facilitated to instantly decide a current progress status of a broadcast program via the progress bar.

The progress bar shown in FIG. 4 is capable of displaying whether a progress status of a broadcast program is in ‘recording (RE)’ or in ‘playing (TS)’. Namely, the progress bar is able to display a presence or non-presence of a progress of a broadcast program and a type (RE or TS) of the progress on an area 60. In case that a broadcast program view-reserved by a user is being played, characters ‘TS’ can be displayed in the area 60. Also, in case that a broadcast program record-reserved by a user is being recorded, characters ‘RE’ can be displayed in the area 60. A progressive extent of a broadcast program, i.e., a current recording or play progress complete quantity can be displayed in a figure of a bar 63 in the area 62. In doing so, since a total recording or play quantity 64 of the broadcast program is displayed together, a user is facilitated to recognize a progressive portion of a total quantity 64 of the broadcast program though the progress bar.

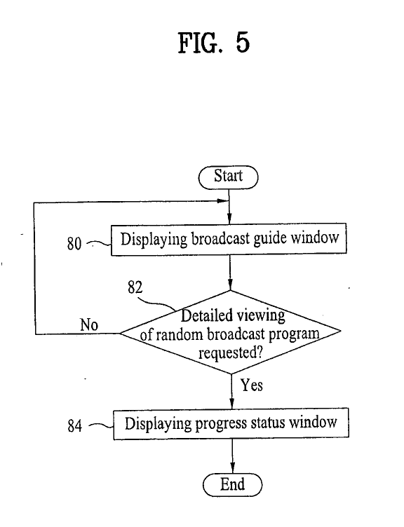

FIG. 5 shows an example of the step S22 shown in FIG. 2.

Referring to FIG. 5, if a detailed viewing of a random one of broadcast programs is requested, a progress status of the corresponding broadcast program is displayed through a progress status window (Steps 80 to 84). The method shown in FIG. 5 is additionally explained with reference to FIG. 3 as follows.

First of all, upper lists are displayed via the broadcast guide window 42 (S80).

After completion of the step S80, it is decided whether a detailed viewing of a random one of broadcast programs shown in the broadcast guide window 62 is requested (S82). A user is able to select the detailed viewing of the random broadcast program 44 from the broadcast programs shown within the broadcast guide window 42. If the detailed viewing of the random broadcast program is not requested, it goes to the step S80 to keep displaying the broadcast guide window 42.

Yet, if the detailed viewing of the random broadcast program, e.g., the broadcast program 44 having the title of ‘Alone’ is requested by a user, a progress status window 43 of the broadcast program 44 of ‘Alone’ is displayed (S84). Hence, a viewing or recording progress status of the broadcast program ‘Alone’ can be provided to the user via the progress status window 40 or 43.

After completion of the step S22, it is decided whether the broadcast guide is to be updated (S24). The EPG information can be changed in correspondence to situations of a broadcasting station that transmits broadcast signals.

According to one embodiment of the present invention, the broadcast receiver, as shown in FIG. 2, displays an updated broadcast guide if there exists an update of the broadcast guide corresponding to the EPG information (S22).

According to another embodiment of the present invention, unlike FIG. 2, the broadcast receiver is able to proceed to the step S16 instead of proceeding to the step S22 if there exists the update of the broadcast guide corresponding to the EPG information.

For instance, if a user makes a reservation of a recording or viewing of a broadcast program, the broadcast receiver obtains a start time of the broadcast program, of which recording or viewing is reserved by the user, from the EPG information obtained from the step S14 and then starts to record or play the user-reserved broadcast program at the obtained start time.

Yet, if the start time of the broadcast program, of which viewing or recording was reserved by the user, is updated due to situations of a broadcasting station, the broadcast receiver obtains an updated start time from the updated EPG information and then starts to record or play the user-reserved broadcast program at the obtained start time.

Thus, in case that it is necessary to generate progress status information for a broadcast program to be recorded or played in correspondence to an updated recording or play time, if there exists an update of a broadcast guide corresponding to EPG information, the routine goes to the step S16.

A configuration and operation of a broadcast receiver for performing the method shown in FIG. 2 or FIG. 5 is explained with reference to the accompanied drawings as follows.

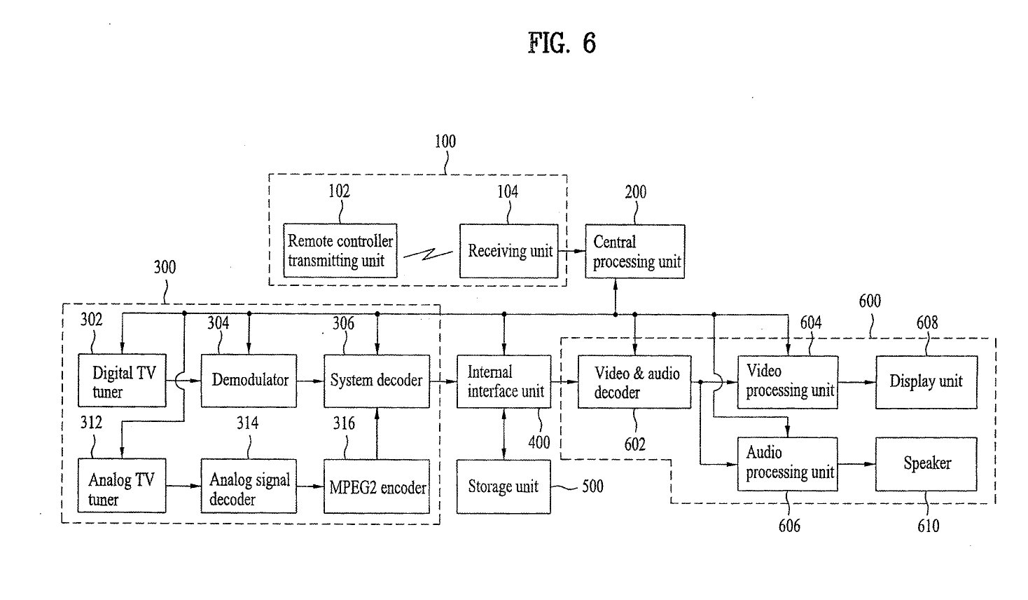

First of all, a broadcast receiver, as shown in FIG. 6, includes a user interface unit 100, a central processing unit 200, a broadcast signal receiving unit 300, an internal interface unit 400, a storage unit 500, and a broadcast outputting unit 600.

In order to perform the steps S10 and S12, the broadcast signal receiving unit 300 shown in FIG. 6 receives a broadcast signal, extracts additional information from the received broadcast signal, and then outputs the extracted additional information to the central processing unit 200, under the control of the central processing unit 200. For this, the broadcast signal receiving unit 300 includes a digital TV tuner 302, a demodulator 304, a system decoder 306, an analog TV tuner 312, an analog signal decoder 314, and an MPEG2 encoder 316.

In order to perform the step S10, the digital TV tuner 302 physically tunes a specific channel and then receives a transport stream (TS) type digital broadcast signal on the tuned channel, under the control of the central processing unit 200. In this case, the transport stream can be the data encoded in MPEG compression format.

The demodulator 304 demodulates the digital broadcast signal (or, the TS) of the channel tuned by the digital TV tuner 302.

The analog TV tuner 312 receives an analog broadcast signal on the tuned channel. The analog signal decoder 314 then decodes the analog broadcast signal received from the analog TV tuner 312. The MPEG encoder 316 encodes the broadcast signal decoded by the analog signal decoder 314 into an MPEG2 digital signal.

In order to perform the step S12, the system decoder 306 decodes the broadcast signal provided by the demodulator 304 or the MPEG2 encoder 316 to output a video signal, an audio signal, and a data signal. In particular, the system decoder 306 can include a built-in demultiplexer (not shown in the drawing) that separates the digital broadcast signal provided by the demodulator 304 into an audio signal, a video signal and a data signal to output.

Thus, the data signal including the additional information can be extracted from the broadcast signal via the broadcast signal receiving unit 300.

The user interface unit 100 is provided with various control commands by a user. For this, the user interface unit 100 can be implemented with a remote controller transmitting unit 102 and a receiving unit 104.

The remote controller transmitting unit 102 receives a channel selection for a reservation, recording or viewing from a user and then generates a control command.

The remote controller unit 102 transmits the generated control command to the receiving unit 104 by wireless. The control unit 104 receives the control command transmitted by the remote controller unit 102 and then delivers the received control command to the central processing unit 200.

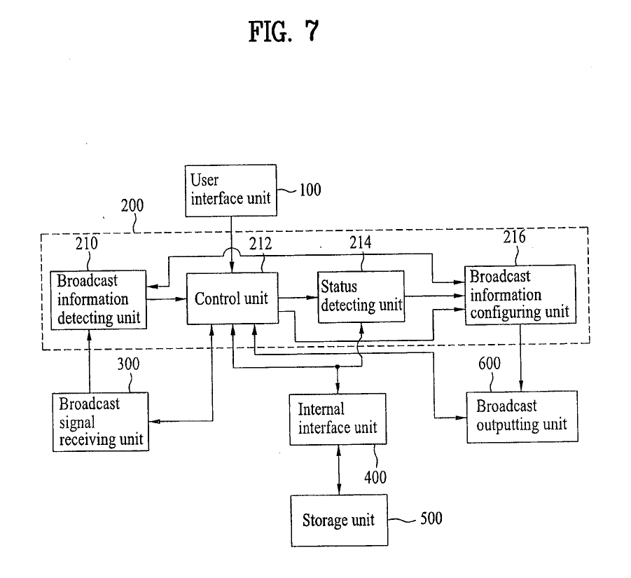

The central processing unit 200 controls the respective units of the broadcast receiver according to the control command delivered by the receiving unit 104. For this, the central processing unit 200, as shown in FIG. 7, includes a broadcast information detecting unit 210, a control unit 212, a status detecting unit 214, and a broadcast information configuring unit 216.

In order to perform the step S14, the broadcast information detecting unit 210 detects EPG information from the additional information extracted by the broadcast signal receiving unit 300 and then outputs the detected EPG information to the control unit 212 and the broadcast information configuring unit 216. In correspondence to the control command received from the user interface unit 100, the control unit 212 controls the respective units for the recording or playback of a specific broadcast program included within the EPG information.

For instance, assuming that a user made a reservation of a recording of a broadcast program ‘Alone’ via the user interface unit 100′, the control unit 212 recognizes that the broadcast program ‘Alone’ will be broadcasted on a second channel (CH. 2) from 16:30 to 17:40 via the EPG information received from the broadcast information detecting unit 210. In this case, the control unit 212 controls the digital TV tuner 302 to tune the second channel (CH. 2) at 16:30 and also controls the respective units 304, 306 and 400 to enable the broadcast program ‘Alone’ received on the tuned channel to be stored in the storage unit 500. So, the broadcast program ‘Alone’ broadcasted from 16:30 can be recorded in the storage unit 500 according to the corresponding reservation.

In order to perform the step S16, under the control of the control unit 212, the status detecting unit 214 obtains progress Status information for a broadcast program selected in real time by a user or for a broadcast program selected according to a reservation.

In particular, the control unit 212 confirms an overall operational status of the broadcast receiver and decides whether a recording function or a viewing function is operating. If the recording function is operating, the control unit 212 controls the status detecting unit 214 to generate progress status information by checking a current recording progress status of a broadcast program selected from a plurality of broadcast programs by a user. Yet, if the viewing function is operating, the control unit 212 controls the status detecting unit 214 to generate progress status information by checking a currently played progress extent of a broadcast program selected from a plurality of broadcast programs by a user.

In order to perform the step S18, the broadcast information configuring unit 216 configures broadcast information in a manner of adding the progress status information detected by the status detecting unit 214 to the EPG information detected by the broadcast information detecting unit 210. The configured broadcast information is used to display at least one of the broadcast guide window and the progress status window shown in FIG. 3. For this, the broadcast information configuring unit 216 can include an OSD unit (not shown in the drawing) for generating an OSD (on screen display) signal for displaying the progress status window overlapped with the broadcast guide window or another OSD signal for displaying a separate progress status window outside the broadcast guide window.

The internal interface unit 400 plays a role in interfacing the broadcast signal receiving unit 300, the central processing unit 200, the storage unit 500, and the broadcast outputting unit 600. In particular, the internal interface unit 400 connects the system decoder 306 and the storage unit 500 together and the storage unit 500 stores the video and audio signals decoded by the system decoder 306. And, the storage unit 500 stores the EPG information and the progress status information received from the central processing unit 200 via the internal interface unit 400.

The broadcast outputting unit 600 displays the progress status information on each of the progress status window and the broadcast guide window together with the EPG information under the control of the central processing unit 200. For this, the broadcast outputting unit 600 includes a video & audio decoder 602, a video processing unit 604, an audio processing unit 606, a display unit 608, and a speaker 610.

The video & audio decoder 602 decodes video and audio signals provided by the system decoder 306 or the storage unit 500 via the internal interface unit 400.

The video processing unit 604 detects the video signal from the decoded signal and then processes the detected video signal. And, the video processing unit 604 is capable of synthetically processing the detected video signal and the OSD signal generated by the OSD unit together.

The display unit 608 displays the video processed by the video processing unit 604 on the screen.

The audio processing unit 606 detects the audio signal from the decoded signal and then processes the detected audio signal.

And, the speaker 610 outputs the audio processed by the audio processing unit 606.

In order to perform the step S20, the control unit 212 checks whether a display of a broadcast guide is requested. The display of the broadcast guide can be requested in real-time by a user via the user interface unit 100 or requested as a default preset by a user to be automatically displayed on the screen each time a power of the broadcast receiver is turned on/off.

In order to perform the step S22, if it is decided that the display of the broadcast guide is requested, the control unit 221 controls the broadcast information configuring unit 216 to generate an OSD signal for the broadcast guide and then controls the video processing unit 604 to synthesize the generated OSD signal with the video signal. Hence, at least one of the broadcast guide window and the progress status window can be displayed as the broadcast guide.

In order to perform the step S24, if the EPG information currently received from the broadcast information detecting unit 210 is different from the previously received EPG information, the control unit 212 updates the previously received EPG information into the currently received EPG information. As mentioned in the foregoing description, according to the updated EPG information, the control unit 212 controls the recording or play of the broadcast program or the generation of the progress status information.

Meanwhile, in order to perform the step S80 shown in FIG. 5, the broadcast information configuring unit 216 generates an OSD signal for a broadcast guide window and the video processing unit 604 processes the OSD signal for the broadcast guide window to be synthesized with the video signal. A result of the synthetic processing is displayed via the display unit 608.

In order to perform the step S82, the control unit 212 decides whether a detailed viewing of a random broadcast program is requested. The detailed viewing of the random broadcast program can be requested by a user via the user interface unit 100. For instance, if a cursor is displayed on each broadcast program shown in FIG. 3, a user manipulates the remote controller transmitting unit 102 to move the cursor to a specific broadcast program for the detailed viewing and then selects the broadcast program where the cursor is located. If so, a control command for the selected broadcast program is generated. The control unit 212 interprets the generated control information and then controls the respective units to display a progress status window of the user-selected broadcast program.

In order to perform the step S84, under the control of the control unit 212, the broadcast information configuring unit 216 generates an OSD signal for broadcast guide and progress status windows. The video processing unit 604 synthesizes the OSD signal for the broadcast guide and progress status windows with a video signal. Hence, a result of the synthetic processing by the video processing unit 604 can be displayed via the display unit 608.

Accordingly, the present invention provides the following effects or advantages.

First of all, the present invention obtains reserved recording information and reserved viewing information for a broadcast program from EPG information to display the obtained information via broadcast guide window. And, the present invention displays progress status information for a recorded or played broadcast program via a progress status window. Hence, the present invention facilitates a user to recognize a recording progress status or a play progress status of a broadcast program instantly.

Secondly, the present invention provides progress status information as bar type graphic information, thereby enabling a user to recognize progress information more intuitively and instantly.

A computer readable recording medium includes all kinds of storage devices in which data readable by a computer system is stored. As a example of the computer-readable recording medium, there is ROM, RAM, CD-ROM, magnetic tape, floppy disc, optical data storage device or the like as well as a device implemented in a carrier wave from (e.g., transmission via Internet). The computer-readable recording medium is distributed to computer systems connected via network and codes readable by a computer by a distributive system can be stored in the computer-readable computer to be executed. And, it is apparent to those programmers skilled in the art of the present invention that functional programs, codes and code segments for the implementation of a user tracking method can be easily inferred.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of operating a broadcast receiver, comprising the steps of:
extracting additional information from a received broadcasting signal;
obtaining EPG information associated with a schedule of broadcasting programs using the extracted additional information;
generating progress status information by checking a progress status in which a broadcasting program selected from the broadcasting programs is currently processed; and
configuring broadcast information by adding the generated progress status information to the obtained EPG information.

2. The method of claim 1, further comprising the step of displaying a broadcast guide window corresponding to the EPG information and a progress status window corresponding to the progress status information together using the broadcast information.

3. The method of claim 1, the progress status checking step comprising the step of checking the progress status of a recording of the selected broadcast program.

4. The method of claim 1, the progress status checking step comprising the step of checking the progress status of a playback of the selected broadcast program.

5. The method of claim 2, wherein the broadcast guide window represents at least one selected from the group consisting of a reserved recording status of the selected broadcast program and a reserved viewing status of the selected broadcast program.

6. The method of claim 2, wherein the broadcast guide window represents at least one selected from the group consisting of a recording end status of the selected broadcast program and a play end status of the selected broadcast program.

7. The method of claim 1, wherein the selected broadcast program is selected by a reservation.

8. The method of claim 7, wherein the reservation is made for a recording.

9. The method of claim 7, wherein the reservation is made for a viewing.

10. The method of claim 2, wherein the progress status window is displayed in a manner of being overlapped with an inside of the broadcast guide window.

11. The method of claim 2, wherein the progress status window is separately displayed outside the broadcast guide window.

12. The method of claim 2, wherein the progress status window is displayed in a pop-up figure together with the broadcast guide window.

13. The method of claim 1, wherein the progress status window has a progress bar type figure.

14. The method of claim 1, wherein the progress status information comprises at least one selected from the group consisting of a presence or non-presence of a recording progress of the selected broadcast program, a recording start time of the selected broadcast program, a recording end time of the selected broadcast program, a current recording complete quantity of the selected broadcast program, and a total recording quantity of the selected broadcast program.

15. The method of claim 1, wherein the progress status information comprises at least one selected from the group consisting of a presence or non-presence of a play progress of the selected broadcast program, a play start time of the selected broadcast program, a play end time of the selected broadcast program, a current play complete quantity of the selected broadcast program, and a total play quantity of the selected broadcast program.

16. The method of claim 14 or claim 15, the current recording or play quantity is represented by a unit of percentage or time to the total recording o play quantity.

17. The method of claim 2, wherein if a detailed viewing of the selected broadcast program is requested on the broadcast guide window, the progress status window is displayed.

18. A broadcast receiver comprising:
a broadcast signal receiving unit extracting additional information from a received broadcasting signal;
a broadcast information detecting unit detecting EPG information associated with a schedule of broadcasting programs using the extracted additional information;
a status detecting unit generating progress status information by checking a progress status in which a broadcasting program selected from the broadcasting programs is currently processed; and
a broadcast information configuring unit configuring broadcast information by adding the generated progress status information to the obtained EPG information.

19. The broadcast receiver of claim 18, further comprising a display unit displaying a broadcast guide window corresponding to the EPG information and a progress status window corresponding to the progress status information together by processing the broadcast information.

20. The broadcast receiver of claim 18, the broadcast information configuring unit comprising an OSD (on screen display) unit generating an OSD signal for displaying a progress status window for indicating the progress status information to be overlapped with a broadcast guide window corresponding to the EPG information.

21. The broadcast receiver of claim 18, the broadcast information configuring unit comprising an OSD (on screen display) unit generating an OSD signal for displaying a progress status window for indicating the progress status information outside a broadcast guide window corresponding to the EPG information separately.

22. The broadcast receiver of claim 18, further comprising a demultiplexer separating the received broadcast signal into an audio signal, a video signal and a data signal to output, wherein the broadcast signal receiving unit extracts the additional information from the data signal.
